(19) United States
(12) Patent Application Publication
(10) Pub. No.: US 2007/0189010 A1
(43) Pub. Date: Aug. 16, 2007

(54) Light diffusing element

(76) Inventor: Susumu Arai, Koshigaya-shi (JP)

Correspondence Address: SNELL & WILMER LLP (OC), 600 ANTON BOULEVARD, SUITE 1400, COSTA MESA, CA, 92626, US

(21) Appl. No.: 10/584,734

(22) PCT Filed: Dec. 22, 2004
(86) PCT No.: PCT/JP04/19723

§ 371 Date: Jun. 26, 2006

(30) Foreign Application Priority Data
Dec. 28, 2003 (JP) 2003-436935

(51) Int. Cl. F21S 6/00; F21V 3/00; F21S 8/10; F21V 5/00

(52) U.S. Cl. 362/257; 362/311; 362/317

(57) ABSTRACT

A light diffusing element is invented which includes: a passage part which passes, as first light, light traveling in substantially parallel to an optical axis while almost not scattering the light, and a diffusion part which scatters light spreading outward from the optical axis by a predetermined angle or more and emanates the light as second light, in which the second light controls illuminance distribution in a light irradiation area defined by a region which is irradiated with the first light. According to the light diffusing element, optical loss can be minimized, the diffusion angle and the light irradiation area can be favorably controlled, and lower cost can be achieved.

### FIELD OF THE INVENTION

The present invention relates to a light diffusing element for diffusing light emitted from a low-heat type illuminator, such as a commercially available LED, to control illuminance distribution in a predetermined light irradiation area.

### PRIOR ART

In illumination (light irradiation) applications, light diffusion and shaping are frequently performed, because there is more or less unevenness in radiation of light emitted from the illuminator, which causes a light irradiation area, so-called illumination unevenness (unevenness in the illuminance distribution). That is, it is an object of light diffusion and shaping processing to diffuse all raw light emitted from the illuminator to thereby process it into soft light with high evenness so as to resolve the illumination unevenness and, at the same time, to make the shape of the illuminance distribution in the light irradiation area closer to a desired shape.

Optical elements used to achieve such an object are called diffusers (light diffusing elements), which are known as a transmissive type, such as ground-glass, opal glass, a holographic diffuser, and the like, or which are known as a reflective type, such as a Halon plate used for a beam splitter and the like.

The ground-glass is formed by subjecting one or both surfaces of a glass plate to delustering by way of sandblasting or the like, and is widely used since it requires low cost material and involves easy processing. The opal glass is usually formed by using a glass plate as a substrate and applying an opal layer to one surface thereof, and has more excellent light diffusion effect than the ground-glass.

However, these ground-glass and opal glass suffer from difficulties in the controllability of light diffusion characteristics (diffusion angle and transmission efficiency), against which no measures can be taken at this point. More specifically, the ground-glass and opal glass have extremely low transmission efficiency and also have short longitudinal coverage, which inevitably requires the use of an extremely high-power illuminator. In addition, the ground-glass and opal glass have a larger diffusion angle than necessary, which inevitably requires an additional large-diameter lens, an expensive filter, and the like for condensing light on a predetermined light irradiation area. Due to these aspects, problems arise in terms of the energy use efficiency, the total cost, the compactness, and the like.

On the other hand, the holographic diffuser is an element that has been recently developed to improve the difficulties described above. As shown in patent document and the like, this is provided by forming a computer-designed, bumpy groove pattern (hologram pattern) of approximately 5 μm in length on a resin such as polycarbonate, or substrate such as a synthetic quartz plate, and can achieve Gaussian-like illuminance distribution and improve the proportionality level of a light irradiation area by diffusing the central light brightness and distributing it to the surrounding region. The diffusion angle can basically be set at an arbitrary angle, and light shaping can easily be performed. In addition, the transmittance is around 85%, which is better than the ground-glass and the like described above.

However, this holographic diffuser has a drawback of high price. In addition, the holographic diffuser is designed on the assumption that parallel light is made incident; thus, when divergent light traveling away from an optical axis with some spread angle is made incident, the controllability of this spread angle cannot be maintained. That is, depending on the type of an illuminator the user arbitrarily purchases, the holographic diffuser cannot achieve its full performance. Thus, in this sense, the holographic diffuser can be said to be a so-called difficult-to-use element with greatly limited compatibility in its combination with the illuminator. Moreover, the transmittance is as low as approximately 85% as described above, which is far from being high efficiency.

As described above, a diffuser of a transmissive type cannot improve the efficiency to more than a certain degree, due to emergence of light reflected on the diffuser surface or light absorbed inside at the time of transmission.

On the other hand, for example, a reflective type, such as a Halon plate or the like, has more excellent efficiency than that of a transmissive type but has difficulties in the controllability of the spread angle, consequently causing optical loss.

Further, in any of those described above, which are based on the idea that all light emitted from the illuminator is to be diffused, insufficient space between a light source and a diffuser results in failure to provide sufficient diffusion effect and thus failure to maintain evenness of illuminance distribution in the light irradiation area. This consequently makes it difficult to provide configuration which is compact in the length direction. In addition, separating the light source from the diffuser by some degree increases the area of light irradiation on the diffuser surface, which requires upsizing the diffuser itself and also requires a large lens to further condense light after diffused, thus failing to maintain the compactness in the radial direction. On the contrary, downsizing the diffuser and the lens increases light not to be used, thus resulting in deteriorated efficiency.
Patent document 1: Japanese Unexamined Patent Publication No. 2000-267088

### DISCLOSURE OF THE INVENTION

It is a main desired object of the invention to provide a light diffusing element which directly passes light substantially parallel to the optical axis without diffusing it while diffusing only light spreading to the surrounding thereof to thereby ensure the evenness of illuminance distribution in a light irradiation area, which has minimum optical loss, which is excellent in the diffusion angle and the controllability of the light irradiation area, which can easily be downsized, and further which has simple configuration applicable to any illuminator.

More specifically, a light diffusing element according to the present invention comprises: a passage part which is provided on an optical axis of light emitted from the illuminator and which passes, as first light, light traveling in substantially parallel to the optical axis while almost not scattering the light; and a diffusion part which is provided around the passage part and which scatters light spreading outward from the optical axis by a predetermined angle or more and emanates the light as second light, wherein a light irradiation area defined by a region irradiated with the first light is irradiated with the second light by the diffusion part to control illuminance distribution in the light irradiation area.

With such a light diffusing element, of light emitted from the illuminator, the light parallel or nearly parallel to the optical axis pass directly through the passage part to reach the light irradiation area without little loss, thus permitting achieving a great improvement in the efficiency compared to the one, such a conventional one, which diffuses all the light. In addition, the passage part is just required to be provided with, for example, a hole, and the diffusion part is also just required to have a diffuse reflection surface and a transmission diffusion member formed around the hole, thus permitting achieving very simple configuration. Moreover, due to easy light control by the diffusion part, excellent controllability of the illuminance distribution in the light irradiation area is provided. Further, the controllability is not disturbed even when the illuminator is located close thereto, thus permitting greater downsizing is achieved compared to a conventional one.

Here, “while not scattering the light” means that one ray of light travels straight or while being bent without diverging.

To provide preferable applications for spot illumination or the like, it is desirable that the illuminance distribution be so configured as to keep a predetermined evenness level.

To improve the degree of control freedom, it is preferable that an optical element for refracting light be provided in the passage part.

To diffuse light spreading by a predetermined angle or more by way of “reflection” to maximize the efficiency, it is preferable that the diffusion part be composed of a diffuse reflection surface which is so arranged as to surround the optical axis of the light from the side periphery and which is oriented inwardly, and that the passage part be set in space formed by being surrounded by the diffuse reflection surface.

Further, with the light diffusing element configured as described above, only specifying the shape and size of the diffuse reflection surface permits easy adaptation to the required shape and illuminance distribution characteristics of the light irradiation area, which is also extremely excellent in the controllability of irradiation light. This means that, for existing various illuminators arbitrarily selected by the user, irradiation light can easily be controlled in accordance with characteristics thereof, thus providing an easy-to-use light diffusing element with little limitation in the compatibility of its combination with the illuminator. In addition, when an optical element, such as a lens or the like, is to be combined, in order to achieve maximum performance thereof, the shape and the like can easily be designed in accordance with the provided optical element, so that various merits can be received by designing completely different from that of a conventional one.

To more easily achieve the present invention, the diffuse reflection surface may be formed on an inner surface of a cylinder which is parallel to the optical axis.

To permit light emitted rearward from the illuminator to be guided to the light irradiation area for even further improvement in the efficiency, it is preferable that a reflection surface which is provided at a side opposite to a light exit direction of the illuminator and which has a surface direction with a component facing the light exit direction side.

Other detailed embodiments include the one which the diffusion part is composed of a transmission and scattering member which scatters light while passing the light.

Other detailed embodiments of the illuminator include an LED, an SLD, an LD, an EL element, a cold cathode-ray source, or a light exit end of a light guide.

Effect of the Invention

According to the present invention described above, an easy-to-use light diffusing element can be provided with lower cost, minimum optical loss, and very simple configuration.

Preferred Embodiments of the Invention

### BRIEF DESCRIPTION OF THE DRAWINGS

FIG. 1 is a longitudinal cross section showing the overall configuration of a light diffusing element according to one embodiment of the present invention.

FIG. 2 is a schematic diagram showing a mode of light diffusion performed by the light diffusing element according to the same embodiment.

FIG. 3 is a diagram of illuminance distribution showing one example of illuminance distribution of a light irradiation area according to the same embodiment.

FIG. 4 is a photographic diagram of the light irradiation area according to the same embodiment actually photographed.

FIG. 5 is a photographic diagram of the light irradiation area actually photographed with a different light irradiation device.

FIG. 6 is a schematic perspective view showing a light diffusing element according to another embodiment of the present invention.

FIG. 7 is a schematic perspective view showing a light diffusing element according to still another embodiment of the present invention.

FIG. 8 is a schematic longitudinal end view showing a light diffusing element according to still another embodiment of the present invention.

FIG. 9 is a schematic longitudinal end view showing a light diffusing element according to still another embodiment of the present invention.

FIG. 10 is a schematic longitudinal end view showing a light diffusing element according to still another embodiment of the present invention.

FIG. 11 is a schematic diagram showing a mode of light diffusion performed by the light diffusing element according to the same embodiment.

FIG. 12 is a schematic longitudinal end view showing a light diffusing element according to still another embodiment of the present invention.

FIG. 13 is a schematic longitudinal end view showing a light diffusing element according to still another embodiment of the present invention.

FIG. 14 is an elevation view showing a light diffusing element according to still another embodiment of the present invention.

### BEST MODE FOR CARRYING OUT THE INVENTION

One embodiment of the present invention will be described referring to the drawings.

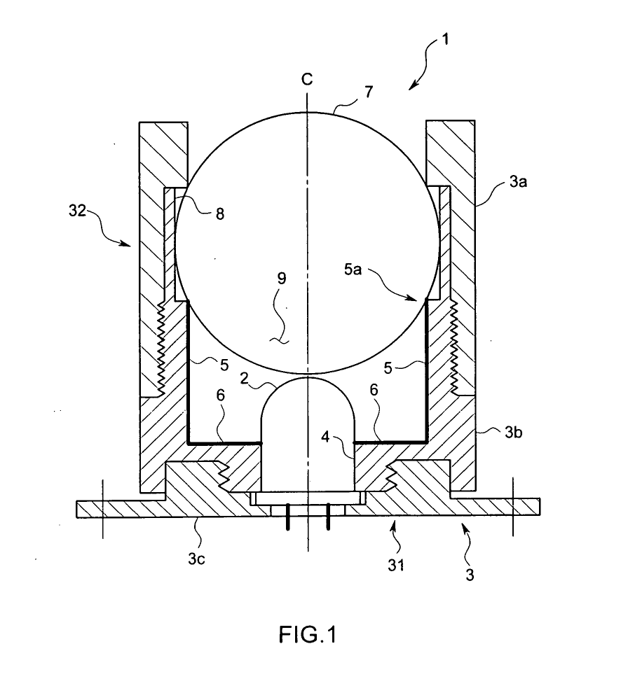

A light diffusing element 1 according to the present embodiment comprises, as shown in FIG. 1, a structure 3 of a cylindrical shape opening at the leading end thereof and composed of a bottom plate 31 of a disc shape which holds on the center thereof an LED 2 as an illuminator and a side peripheral plate 32 which stands up from the peripheral edge of the bottom plate 31. The light diffusing element 1 composes a light irradiation device by being built therein integrally with the LED 2, a power source, not shown in the drawings, and the like.

This structure 3 has, as members thereof, for example, three elements: namely, a leading end element 3a, an intermediate element 3b, and a base end element 3c, which are screwed and combined together in this order. The leading end element 3a forms the leading end part of the side peripheral plate 32 and is formed into a cylindrical shape. The intermediate element 3b forms the base end part of the side peripheral plate 32 and the inner surface of the bottom plate 31 and is formed into a cylindrical shape with the base end surface thereof closed. The base end element 3c forms the outer surface of the bottom plate 31, is formed into a disc-like shape, and is configured to be fitted to a base material.

In the center of the bottom plate 31 of the structure 3 configured as described above, a through-hole 4 as a LED holding part is provided which fits and holds the LED 2. Then, the LED 2 is firmly fitted with the through-hole 4 so that an optical axis C thereof agrees with a central axis of the structure 3. Axial positioning of the LED 2 is achieved by close contact between a flange part formed at the bottom part of the LED 2 and the bottom surface of the intermediate element 3b. The LED 2 is of a type which molds an LED element, not shown in the drawings, with a bombshell-shape transparent member, and is adapted to slightly protrude from the through-hole 4 as viewed from the side when fitted and held in the through-hole 4 in a predetermined manner.

In the present embodiment, on the inner surface of the side peripheral plate 32 formed in parallel to the optical axis C, a diffuse reflection surface 5 is inwardly formed as a diffuse reflection part finished to a predetermined surface roughness. In the space so formed as to be surrounded by this diffuse reflection part 5, a passage part 9 is formed which passes, of light emitted from the LED 2, the light parallel or nearly parallel to the optical axis C without scattering it. In addition, on the inner surface of the bottom plate 31, a reflection surface 6 is formed.

The diffuse reflection surface 5 is provided at the base end side of the side peripheral plate 32, and surrounds from the side periphery the LED 2 and the optical axis C of light emitted from the LED 2. The diffuse reflection surface may be formed by applying barium sulfate or the like to the inner surface of the side peripheral plate 32 or by fitting white teflon ring or the like therein.

Further, in the present embodiment, in the side peripheral plate 32, a spherical lens 7 as an optical element is fitted and then fixed. More specifically, the spherical lens 7 has a diameter slightly larger than the inner diameter of the side peripheral plate 32, and has an outer periphery thereof so held as to be fitted in a lens holding groove 8 as a lens holding part so formed as to be orbited to the inner peripheral surface of the side peripheral plate 32. The spherical lens 7 is so arranged as to completely cover a light exit port 5a as an opening at the leading end of the diffuse reflection surface 5 and to partly protrude toward the LED 2 side, and part of the spherical lens 7 composes the passage part 9. Assembly of the spherical lens 7 is achieved by a method of fitting the spherical lens 7 in the leading end of the intermediate element 3b and then screwing the leading end element 3a with the intermediate element 3b to thereby sandwich the spherical lens 7. The spherical lens 7 may be provided adjacent to or in contact with the leading end of the LED 2. In addition, the leading end of the spherical lens 7 is adapted to be located at substantially the same height as that of the leading end of the structure 9.

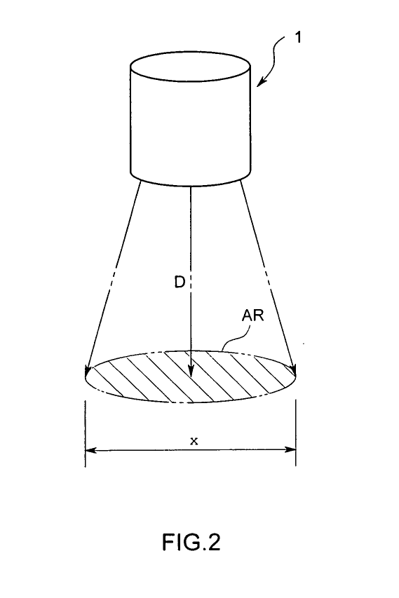

With such a configuration, of light emitted from the LED 2, the light by which an angle is formed with the light optical axis C is within a predetermined angle, that is, the light traveling in parallel or substantially parallel to the optical axis C passes directly through the passage part 9 without scattering although refracted by the spherical lens 7, and then exits to the outside. This first light as exiting light is, as shown in FIG. 2, irradiated to a position separated by a predetermined distance D (actual light crosses on the way in such a manner as to form a X shape), defining a light irradiation area AR. The light irradiation area AR here may be defined so that the first light covers the entire region irradiated. Alternatively, for example, a region with a predetermined proportion of illuminance from the central illuminance may be defined as the light irradiation area AR.

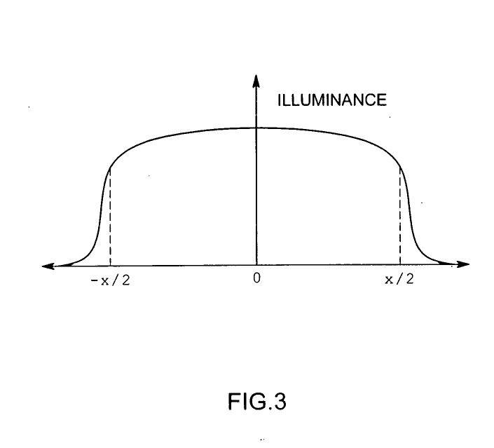

On the other hand, light spreading outward from the optical axis C by a predetermined angle or more scatters and reflects on the diffuse reflection surface 5 once or more, is guided by the spherical lens 7 (optical element), and then exits to the outside. The second light as exiting light polymerizes with the first light and controls the illuminance distribution of the light irradiation area AR so as to keep an evenness level thereof within a predetermined range as shown in FIG. 3.

Therefore, with such a configuration, of light emitted from the LED 2, the light parallel or nearly parallel to the optical axis C exits toward the outside without scattering, causing little loss. In addition, other light that ensures the evenness level of the illuminance distribution of the light irradiation area AR is light that has reached after reflected by the diffuse reflection part 5, also causing little loss. That is, this light diffusing element 1, on one hand, preserves intact light traveling substantially along the optical axis C, and, on the other hand, diffuses only light spreading by a predetermined angle or more by way of “reflection”. Due to its configuration completely different from that of a conventional transmissive type, the light diffusing element 1 can extremely efficiently irradiate the light irradiation area with light from the LED 2.

As long as the shape and size (more specifically, the length and radius) of the diffuse reflection surface 5 are defined, the required shape, size, illuminance distribution characteristics, and the like of the light irradiation area AR can easily be adapted, which is also extremely excellent in terms of controllability. This also means that, for existing various illuminators arbitrarily selected by the user, irradiation light can easily be controlled in accordance with characteristics thereof, thus making it possible to achieve a so-called easy-to-use light diffusing element 1 with little limitation in the compatibility of its combination with the illuminator.

Moreover, the light diffusing element 1 is a simple structure mainly composed of the cylindrical structure 3 and, in addition, has, as an optical element, the low-cost spherical lens 7 just fitted therein, thus also contributing to lowering the cost. In addition, the presence of the spherical lens 7 provides a higher degree of freedom in controlling light. Further, a closer distance between the LED 2 and the spherical lens 7 can provide a compact configuration.

Moreover, to the rear side of the LED element as an illuminator main body, the reflection surface 6 is provided which faces the light exit port 5a side, so that light emitted to the rear side of the LED element is reflected by the reflection surface 6 to be guided to the light exit port 5a, thus permitting further improvement in the efficiency.

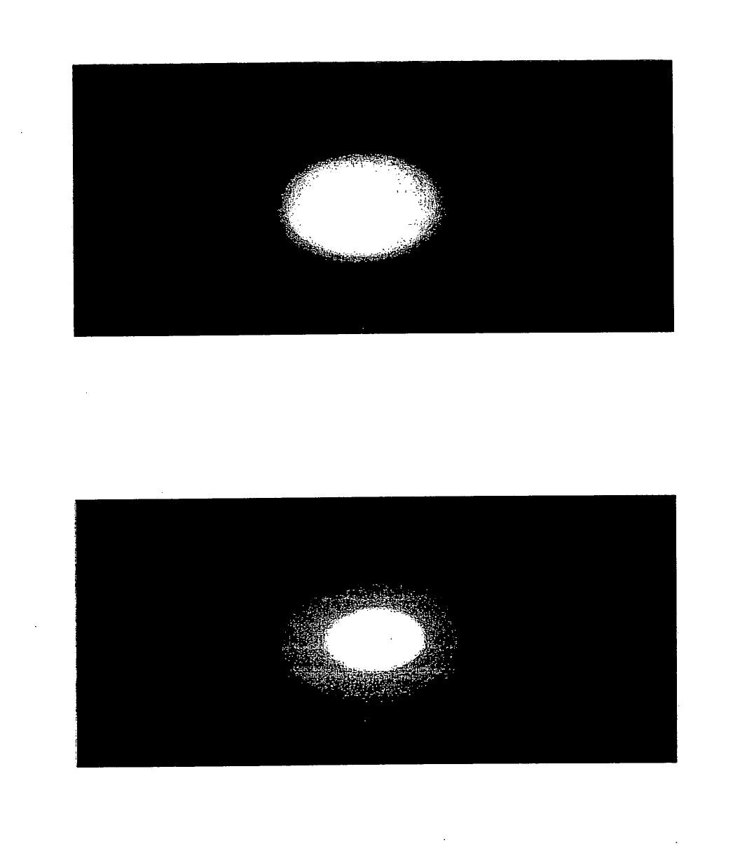

FIG. 4 shows a detailed example of actually photographed illuminance of the light irradiation area AR by using the light diffusing element 1. On the other hand, FIG. 5 shows, as a comparison, an example of light irradiation performed by, under the same condition, a commercially available flashlight-type light irradiation device which has a lens, a reflective mirror, or the like fitted to an LED. According to the light diffusing element 1 of the present embodiment, it would be obvious that there is almost no unevenness in the illuminance distribution of the light irradiation area AR, and, further, the structure is rather simple compared to that of the flashlight described above.

Note that the present invention is not limited to the present embodiment described above. In examples shown in figures below, members corresponding to the present embodiment described above are provided with the same numerals.

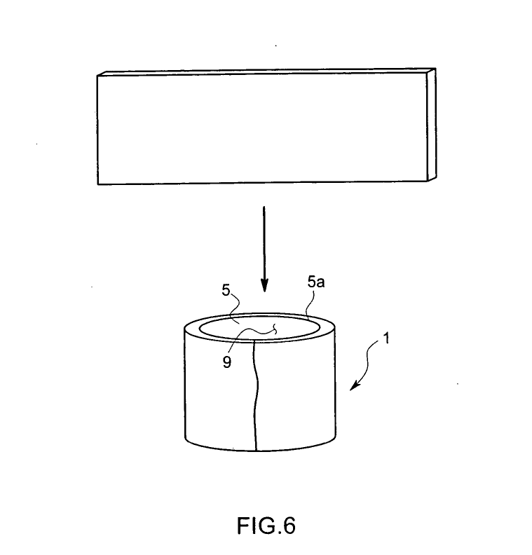

For example, as shown in FIG. 6, a sheet or a plate having a scattering surface may be simply rounded to form the diffuse reflection surface 5 and the passage part 9, which may be provided as the light diffusing element 1. As shown in FIG. 7, a through hole may be provided in a plate material in the thickness direction, and this through hole may be provided as the passage part 9 while the inner peripheral surface of the through hole may be provided as the diffuse reflection part 5. The passage part 9 may be of course fitted with a spherical lens as in the embodiment mentioned above, or a transparent window material of glass, resin, or the like may be fitted therein. Besides, for example, a convex lens, a concave lens, a mirror, a filter, or the like may be provided as an optical element, and may be formed integrally, if necessary, with a member forming a light exit port.

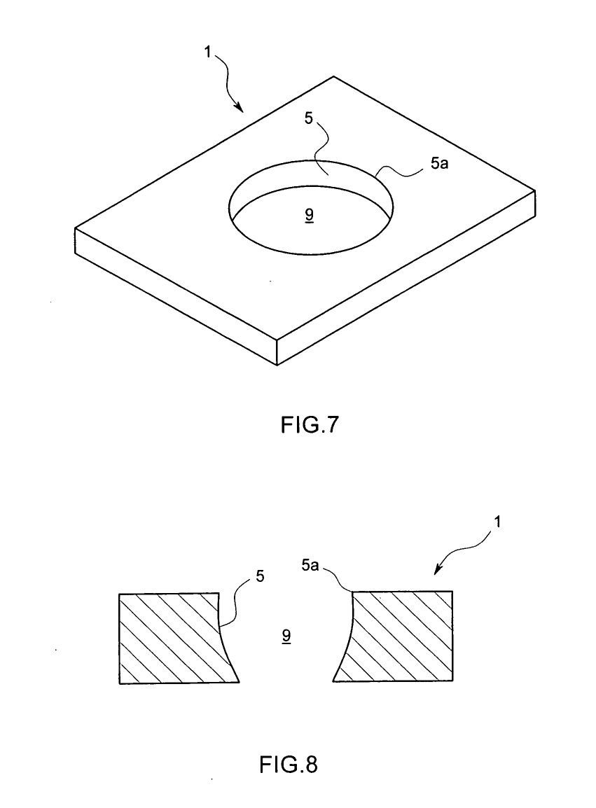

It is desirable that a diffuse reflection surface be formed of a member that reflects light emitted from a light emitting element as efficiently as possible, and it is needless to say that various members may be selected so as to achieve highly efficient reflection by the wavelength of the light. Moreover, the diffuse reflection surface is not limited to the inner surface of a cylinder that is parallel to the optical axis. Thus, the diffuse reflection surface may be a surface oblique to the optical axis, or may be the one whose sectional contour is curved as shown in FIG. 8 to improve the evenness level in the illuminance distribution of the light irradiation area.

The reflection surface 6 is just required to include, in its surface direction, a component facing the light exit port, and thus may be, for example, shaped into a hemisphere formed continuously from the diffuse reflection surface 5 as shown in FIG. 9. In this case, the light exit port 5a may be closed by an optical element or the like, and this inner space may be filled with gas (liquid or solid) having a desired refractive index, such as inactive gas or the like, or may be made vacuum so as to achieve an improvement in the efficiency and the like.

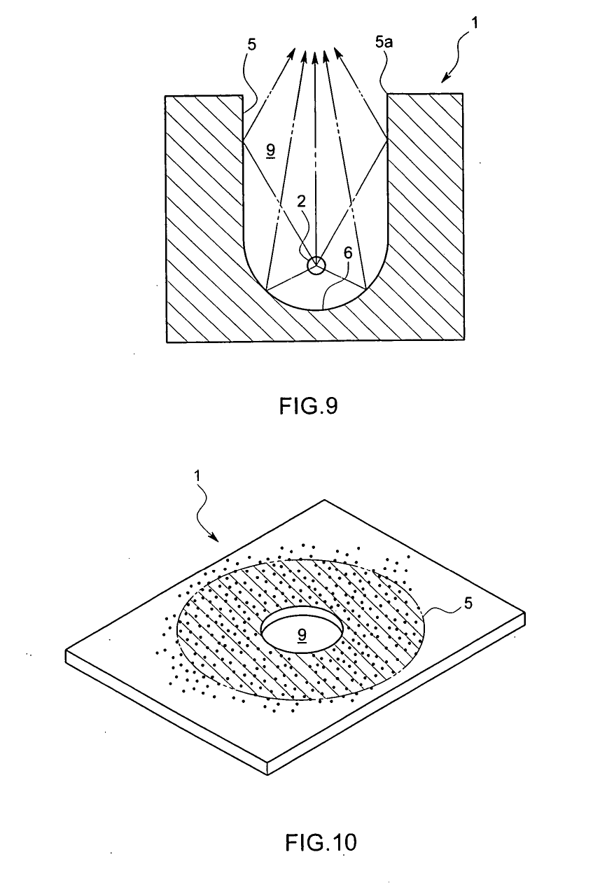

On the other hand, it has been so far described that a diffusion part is a diffuse reflection surface. However, for example, as shown in FIGS. 10 and 11, the diffusion part 5 may be formed by a transmission diffusion member (diffusion plate). In this example, a through hole is formed in a flat-plate like diffusion plate in the thickness direction so that this through hole is provided as the passage part 9 while a diffusion plate portion around the through-hole, that is, the passage part 9, is functioned as the diffusion part 5. Such can be achieved with extremely simple configuration.

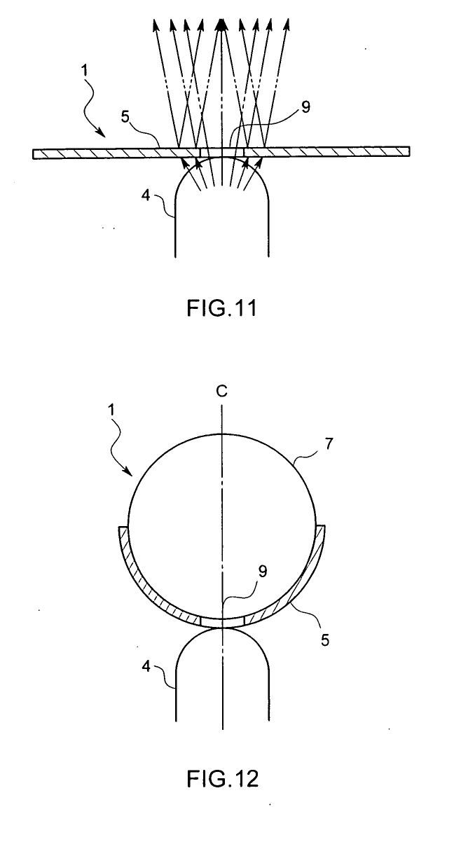

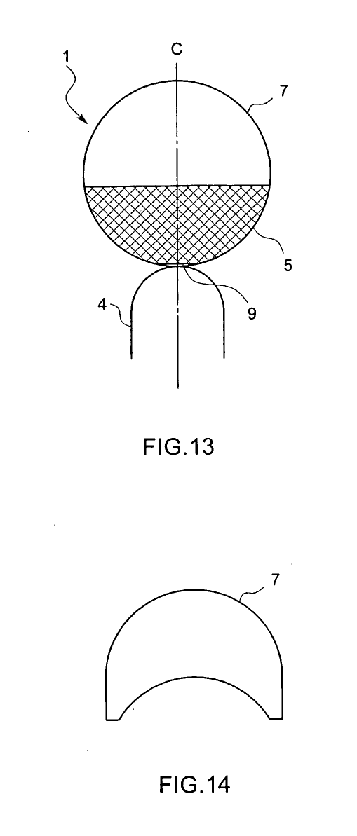

Moreover, a lens may also be provided in this passage part, and for example, as shown in FIG. 12, the diffusion plate may be curved into a spherical shape, in which the spherical lens 7 may be fitted. This idea may be further developed to provide configuration as shown in FIG. 13. That is, a surface at the side peripheral part of the lens 7 may be, for example, roughly formed so as to be provided as the diffusion part 5, and the passage part 9 may be formed at a portion around the optical axis C enclosed by the diffusion part 5.

Further, the diffusion part described above may be of course formed with a member having some light emission characteristic, such as a characteristic of voluntarily emitting fluorescence, phosphorescence, or the like.

An optical element is not limited to a spherical lens. Thus, the optical element may be a hemispherical lens or a typical convex lens, or may be such an optical element 7 that has a concave surface and a convex surface as shown in FIG. 14. Such a large degree of freedom in selecting the optical element as described above is attributable to the fact that the light diffusing element according to the present invention is intended not for imaging but for the controllability of the illuminance distribution in the light irradiation area, which does not require a strict design and structure for the optical element described above. The optical element is of course not necessarily required, and thus, for example, adjacent illumination can provide very even and beautiful illuminance distribution in the light irradiation area even without an optical element.

The illuminator is also not limited to an LED, and thus may be an SLD, an LD, an EL element, a cold cathode-ray source, or the like, or a light exit end of a light guide such as an optical fiber or the like. Even if, like the LED element, the SLD elements, the LD element, and the like, a light emitting element before coated or fitted with a lens component is itself an illuminator, the same effect as in the embodiment described above can be of course exerted. Further, the illuminator may be not only singular but may also be plural. If the illuminator is plural, providing different colors for different illuminators permits color combination.

The invention is not limited to the examples shown in the figures above, and thus various modifications can be made without departing from the spirit of the present intention.

### INDUSTRIAL APPLICABILITY

According to the present invention, an easy-to-handle light diffusing element can be provided with lower cost, minimum optical loss, and very simple configuration.

1. A light diffusing element comprising: a passage part which is provided on an optical axis of light emitted from an illuminator and which passes, as first light, light traveling in substantially parallel to the optical axis while not scattering the light; and a diffusion part which is provided around the passage part and which scatters light spreading outward from the optical axis by a predetermined angle or more and emanates the light as second light, wherein a light irradiation area defined by irradiating the first light is irradiated with the second light by the diffusion part to control illuminance distribution in the light irradiation area.

2. The light diffusing element according to claim 1, wherein the illuminance distribution is so configured as to keep a predetermined evenness level.

3. The light diffusing element according to claim 1, wherein an optical element for refracting light is provided in the passage part.

4. The light diffusing element according to claim 1, wherein the diffusion part is composed of a diffuse reflection surface which is so arranged as to surround the optical axis of the light from a side periphery thereof and which is oriented inwardly, and wherein the passage part is set in space formed by being surrounded by the diffuse reflection surface.

5. The light diffusing element according to claim 4, wherein the diffuse reflection surface is formed on an inner surface of a cylinder which is parallel to the optical axis.

6. The light diffusing element according to claim 4, further comprising a reflection surface which is provided at a side opposite to a light exit direction of the illuminator and which has a surface direction with a component facing the light exit direction side.

7. The light diffusing element according to claim 1, wherein the diffusion part is composed of a transmission and scattering member which scatters light while passing the light.

8. The light diffusing element according to claim 1, wherein the illuminator is an LED, an SLD, an LD, an EL element, a cold cathode-ray source, or a light exit end of a light guide.

9. A light diffusing element comprising: the passage part which is provided on the optical axis of light emitted from the illuminator and which passes, as first light, light traveling in substantially parallel to the optical axis without scattering the light; an optical element which is provided in the passage part and which refracts light; and a diffuse reflection surface which is provided on an inner surface of a cylinder with the optical axis as an axial line and which scatters inwardly light spreading outward from the optical axis by a predetermined angle or more and then emanates the light as second light, wherein a light irradiation area defined by irradiating the first light is irradiated with the second light to control illuminance distribution in the light irradiation area so as to keep a predetermined evenness level.
